(19) United States
(12) Patent Application Publication
(10) Pub. No.: US 2026/0065435 A1
(43) Pub. Date: Mar. 5, 2026

(54) METHOD OF FORMING AN IMAGE WITH A VARIABLE DEGREE OF BLUR ON THE DISPLAY OF A DIGITAL DEVICE

(71) Applicant: Viktor Betcher, Las Vegas, NV (US)

(72) Inventor: Viktor Betcher, Las Vegas, NV (US)

(21) Appl. No.: 18/816,746

(22) Filed: Aug. 27, 2024

(51) Int. Cl. G06T 5/70; G06F 3/01

(52) U.S. Cl. CPC G06T 5/70; G06F 3/013

(57) ABSTRACT

A method for forming an image on a display with a variable degree of blurriness, which is intended to prevent the occurrence and eliminate the development of myopia in users of digital devices with displays—computers, televisions, mobile phones, players, game consoles, virtual reality glasses and the like (hereinafter DDD). This goal is achieved by changing the degree of blurriness (clarity) of the image on the display depending on the tension of the ciliary (accommodative) muscles of the user's eyes. This dependence is ensured by measuring the signal from the ciliary muscles with a sensor, transmitting this signal via a wired or wireless interface to the DDD input, processing the signal using a special program installed in the DDD, which forms an image on the display with a variable degree of blurriness.

### BACKGROUND OF THE INVENTION

### List of Abbreviations and Terms

SMTCEM—Sensor for Measuring the Tension of the user's Ciliary Eyes Muscles;
AP CSVBI—Application Program adapted for work with CSVBI;
CSVBI—Control System of Variable Blur Image
DDD—a Digital Device with a Display on which the user operates;
VDVO—Virtual Distance of the Visualized Object;
IMAGE BLUR—reproduction on the display of the blurred image effect that occurs on the retina of the eye when the image is focused by the crystalline lens not in the plane of the retina (focusing in front of or behind the retina).
DEGREE OF IMAGE BLUR reproduction on the display of the effect of greater or lesser blurriness of the image that occurs on the retina of the eye when the image is focused by the lens at a greater or lesser distance from the plane of the retina of the eye, respectively. The closer the focusing of the image by the lens to the plane of the retina, the lesser the degree of blurriness (the sharper the image). When the focusing of the image coincides with the plane of the retina of the eye, the degree of blurriness is zero (i.e. the image is displayed clearly, without blurriness).

The invention relates to methods of forming an image on the displays of various digital devices—computers, televisions, mobile phones, players, game consoles, virtual reality glasses and the like, hereinafter referred to as digital devices with displays (DDD), the invention also relates to medicine, namely to methods of preventing and treating myopia.

It is known that with the expansion of the use of various digital devices with displays (DDD), as well as with the expansion of the production of information content for DDD (programs, information on the Internet, games, virtual reality, etc.), the volume of visual information consumed is increasing. With the growth of visual information consumed, the average daily time of work of users with DDD and the load on the eyes of users increases accordingly. At the same time, DDD users have a general global trend of deterioration of vision, in particular, the development of myopia.

The main reason for the development of myopia in DDD users is the difference between the natural conditions to which human eyes are adapted in nature during the process of biological evolution, and the conditions in which the eyes of a DDD user work.

This difference is as follows.

When using vision in a natural environment, to form a sharp image on the retina, human eyes constantly reflexively perform the work of adjusting (focusing) the image—the so-called accommodation. The eyes react to a blurry image on the retina and make the muscles work to deform the lens (these muscles are called ciliary) in the right direction, ensuring the focusing of a clear image on the retina. Since usually in a natural environment the direction of a person's gaze changes all the time, surrounding objects are in motion and at different distances, the eyes are constantly in the process of adjustment, and, accordingly, the ciliary muscles of the eyes, responsible for accommodation, are in continuous motion.

Unlike the described conditions of using vision in a natural environment, when a user works with DDD, the image on the display of these devices is always formed sharp and clear, and the ciliary muscles of the eye, having once focused the eyes on the plane of the screen, do not need to continuously perform the work of accommodation. The eye muscles responsible for accommodation are in the same or almost the same state of tension, or in a state of rare accommodation during the entire time of working with the display. With systematic use of DDD, when the eye muscles for accommodation are constantly “idle” for several hours a day, users develop a partial loss of mobility and atrophy of these eye muscles; the ability to accommodate the eyes decreases, which leads to the development of myopia.

The claimed invention, which describes a method for forming an image with a variable degree of blurriness on a display, is intended to eliminate the causes that cause the appearance and development of myopia in DDD users, and is also intended to restore normal visual acuity, weaken and eliminate myopia in users who already have myopia.

In order to “force” the accommodative muscles of the eyes to work when working with DDD, the following principle is implemented in the method claimed in the invention: the degree of blurriness of the image formed on the display is ensured to depend on the degree of tension of the user's ocular ciliary muscles that perform accommodation.

There are known methods for forming an image on display devices in which the dependence of the image on the ergonomic parameters of users is realized. The closest analogue to the claimed invention is patent US 20110134124 A1.

It describes, among other things, a method for forming an image on a display by determining the coordinates of the user's gaze point and displaying an object on which the user's gaze is focused in an enlarged (approximate) form.

The differences between the analogue and the method claimed in this application are as follows:
unlike the analogue, the claimed method does not require determining the coordinates of the user's gaze point on the display (which significantly simplifies and reduces the cost of the display system), the algorithm for forming image blur for all objects simultaneously displayed on the display is the same, depends only on the signal from the SMTCEM sensors and the virtual range assigned to the visualized objects and does not depend on the coordinates of the user's gaze point;
in the claimed method, depending on the signal of the ciliary muscle efforts measured by SMTCEM, a variable blurriness of the visualized objects is formed, while in the analogue, the image to which the user's gaze is directed is simply displayed in an approximate, enlarged form.

### BRIEF SUMMARY OF THE INVENTION

A method for forming an image with a variable degree of blurriness on a display, aimed at preventing the occurrence and eliminating the development of myopia in users of digital devices with displays (hereinafter DDD). This goal is achieved by changing the degree of blurriness (clarity) of the image on the display depending on the tension of the ciliary (accommodative) muscles of the user's eyes. This dependence is ensured by measuring the signal from the ciliary muscles with a sensor, transmitting this signal via a wired or wireless interface to the DDD input, processing the signal using a special program installed in the DDD, and forming an image on the display with a variable degree of blurriness.

### BRIEF DESCRIPTION OF THE DRAWINGS

FIG. 1 shows the diagram of the formation of an image with a variable degree of blur on a DDD display.

FIG. 2 shows an example of the arrangement of test images at different fixed distances from the user used in the SMTCEM calibration procedure.

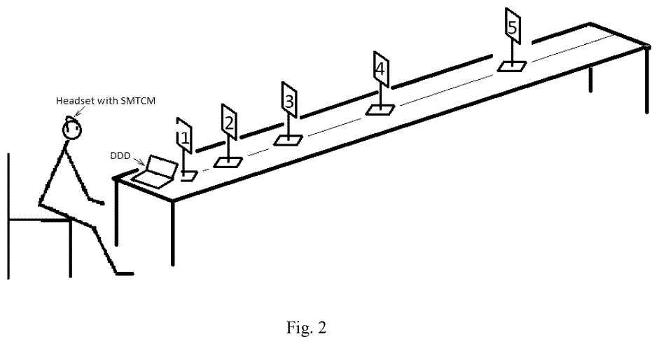

### DETAILED DESCRIPTION OF THE INVENTION

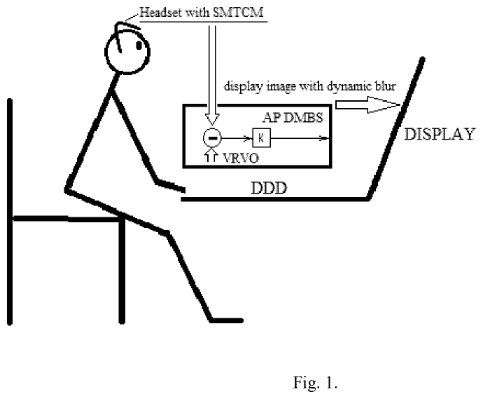

The principle of operation of the dynamic blur control system is explained in FIG. 1.

The system includes:
1) a sensor for measuring the tension of the ciliary muscles of the eyes (accommodation sensor)—SMTCEM.

The sensor generates two signals—the tension of the ciliary muscles of the left and right eyes of the user.

Structurally, SMTCEM can be made in the form of glasses or a headset (hereinafter we will talk about the headset), put on the user's head while working with DDD;

The function of the headset is to pick up signals about the tension of the user's ciliary muscles through the built-in SMTCEM and transmit these signals to the DDD input via a wired or wireless interface;
2) a program for working with CSVBI (AP CSVBI), implementing an algorithm for receiving, processing signals from SMTCEM, and forming an image with dynamic blur on the DDD display.

AP CSVBI is installed on DDD before working with CSVBI.

### The Basic Principle of CSDIB Operation

### SMTCEM Calibration Mode

Before using the CSDIB in the working mode, the user must perform the SMTCEM calibration procedure using the calibration utility included in the AP CSDIB.

The purpose of the calibration is to establish the correspondence of the signals measured by the SMTCEM from the user's ciliary muscles with the values of the real distance to the objects on which the user's gaze is focused at the moment of measuring the SMTCEM signals.

To perform the calibration, signs with clearly distinguishable symbols or large letters are installed at the user's workstation at his eye level along a straight line at fixed specified distances from the user. There are about 5-10 signs in total.

The distances at which the images are installed from the user can be, for example, as follows (in meters): 0.3; 0.5; 1; 2; 3; 5; 7; 10.

The calibration program does the following.

Consecutively for each of the signs installed at different distances:
gives the user an instruction to focus his gaze on the current sign;
after the user focuses his gaze on the specified sign, user gives a confirmation to the program;
after the user's confirmation, the program remembers the values of the signals coming from SMTCEM for the left and right eyes, corresponding to the distance to the current sign.

The values measured during calibration are stored in the program and are used further in the main operating mode of the AP CSVBI program to recalculate signals from SMTCEM into equivalent values of the distance to the focusing objects.

Moreover, interpolation of the data obtained during calibration is used to convert intermediate signal values.

The calibration procedure is mandatory before the first use of the CSDIB system and can then be carried out periodically during the operation of the CSDIB at intervals of about 2-3 weeks, as the accommodative characteristics of the user's eyes change.

### Main Mode of Operation With the CSDIB System

The DDD user places a headset with SMTCEM on his head during work.

The eye accommodation signal from the headset is continuously cyclically (with a repetition period in the range from several tenths of a second to several seconds) read and fed to the DDD input, with which the user works.

The CSDIB AP, based on the SMTCEM signals received from the headset, cyclically (with a repetition period in the range from several tenths of a second to several seconds) calculates and updates the degree of blurriness of the image displayed on the display.

The formation of an image with a variable degree of blur in AP CSDIB is performed according to the following algorithm.

The eye accommodation degree signal coming from SMTCEM via the headset to DDD is filtered from random outliers in AP CSDIB, averaged and recalculated (using data obtained during calibration) into the equivalent distance to which the user's eyes are currently adjusted (accommodative distance). Formation into the equivalent accommodative range can be performed both for the signal from each eye separately and for the averaged signal from both eyes, which can be specified in the program settings.

Each visual object displayed on the screen in AP CSVBI is assigned a so-called virtual distance to this object (VRVO).

VRVO is the distance to which the user's eyes must be focused (accommodated) so that the image of this object on the screen is displayed clearly, not blurry. The VRVO value can be assigned to displayed objects either manually by the user in the AP CSDIB settings, or automatically, including randomly, in the program's operating mode;

For example, when displaying a landscape photograph, the VRVO in the program can be set to 3 meters for a tree in the foreground, and 50 meters for a forest in the background. VRVO values can be generated not only for images of physical objects, but for any objects displayed on the screen. For example, when displaying text, the VRVO can be set to 1.5 meters for one paragraph, 0.5 meters for another, etc.

When displaying a visual object on the AP display, CSDIB compares the value of the accommodative distance to which the user's eyes are currently adjusted, measured by SMTCEM, with the VRVO value of the visualized object. If the difference between the values of the distance to which the user's eyes are adjusted and VRVO is zero, the image is displayed on the screen as clear as possible, without blurriness. If this difference is not zero, the image is displayed blurred, and the greater the absolute value of the difference in distances, the greater the degree of blurriness of the image of the object displayed on the display.

Regardless of the number of objects displayed on the screen at the same time, the degree of blur for all objects is calculated using the same algorithm (i.e. based on the difference between the accommodative and virtual distances), but since the value of the virtual range for different visualized objects may be different, the degree of blur for simultaneously displayed objects may be different.

The sensitivity value between the absolute value of the distance difference and the degree of image blur can be adjusted by the transfer coefficient K (FIG. 1), the value of which can be set in the AP CSDIB setting.

During work with DDD, the user's eyes reflexively perform the work of eye accommodation in order to obtain a clearer image on the display, simultaneously transmitting the signal of efforts from the ciliary muscles through the headset to the AP CSDIB input. The program, if the accommodative range of the eyes approaches the VRVO value, reduces the degree of blurriness of the image on the display; if the absolute value of the difference between the accommodative range and VRVO increases, the degree of blurriness of the image also increases.

Thus, feedback is implemented between the efforts of the eye muscles for accommodation and the degree of blurriness of the image on the display, which is the stated purpose of the invention—stimulating the work of the user's ciliary muscles, preventing, weakening and eliminating myopia during work on DDD.

1. A method for generating an image with a variable degree of blurriness on the display of a digital device on which a user is working, characterized in that during the user's work, the degree of blurriness of the image on the display of the digital device is continuously cyclically (with a repetition period in the range from several tenths of a second to several seconds) calculated and updated, wherein the degree of blurriness of the image is calculated as a value proportional with an adjustable transfer coefficient to the absolute value of the difference of two values, where the first value of said difference is the accommodative distance to which the user's eyes are adjusted at the time of measuring the signals from sensor for measuring the tension of the user's ciliary eyes muscles (SMTCM), calculated on the basis of the measured signals from the SMTCM, where the SMTCM are located in the area of the user's eyes in the form of glasses or a headset, and the second value of said difference is the virtual range of the object visualized on the display generated in the program and specifying the accommodation distance to which the user's eyes must be adjusted, at which the image of the object is displayed clear (not blurred), wherein if calculated as indicated above, the difference between the two specified values is equal to zero, then the degree of blurriness of the image on the display is also equal to zero (the image is displayed sharply), and the degree of blurriness of the image on the display is greater, the greater the absolute value of the above-specified difference multiplied by the adjustable transfer coefficient, wherein the accommodative distance of the user's eyes, used as the first value when calculating the above-specified difference, is calculated on the basis of the received SMTCM signals using interpolation of data obtained in advance before the main mode of operation application program of the control system of variable blur image in the calibration mode, which consists of memorizing the SMTCM signals when focusing the user's gaze on images located at several (about ten) previously known fixed distances from the user in the range of approximately 0.3 m to 10 m.
